(19) United States
(12) Patent Application Publication
(10) Pub. No.: US 2025/0322781 A1
(43) Pub. Date: Oct. 16, 2025

(54) GATE DRIVER, DISPLAY DEVICE INCLUDING THE GATE DRIVER, AND ELECTRONIC DEVICE INCLUDING THE DISPLAY DEVICE

(71) Applicant: Samsung Display Co., Ltd., Yongin-Si (KR)

(72) Inventors: JAEKEUN LIM, Yongin-si (KR); BON-SEOG GU, Yongin-si (KR); JINYOUNG ROH, Yongin-si (KR); HAE-KWAN SEO, Yongin-si (KR)

(21) Appl. No.: 19/007,251

(22) Filed: Dec. 31, 2024

(30) Foreign Application Priority Data
Apr. 15, 2024 (KR) 10-2024-0049905

(51) Int. Cl. G09G 3/32

(52) U.S. Cl. CPC G09G 3/32; G09G 2300/0819; G09G 2300/0842; G09G 2300/0861; G09G 2310/0267; G09G 2310/0286; G09G 2330/021

(57) ABSTRACT

A gate driver includes a plurality of stages. Each of the stages comprises a control circuit configured to receive an input signal in response to a first clock signal and control a voltage of a control node and a voltage of an inverted control node based on the input signal, a carry output circuit configured to output a high gate voltage or a second clock signal as a carry signal in response to the voltage of the control node and the voltage of the inverted control node, and a gate output circuit configured to output the high gate voltage or a gate clock signal as a gate signal in response to the voltage of the control node and the voltage of the inverted control node.

This application claims priority under 35 USC § 119 to Korean Patent Application No. 10-2024-0049905 filed on Apr. 15, 2024 in the Korean Intellectual Property Office (KIPO), the entire disclosure of which is incorporated by reference herein.

### BACKGROUND

### 1. Field

Embodiments of the present inventive concept relates to a gate driver, a display device including the gate driver, and an electronic device including the display device. More particularly, the present inventive concept relates to a gate driver, a display device including the gate driver, and an electronic device including the display device for reducing a power consumption.

### 2. Description of the Related Art

In general, a display device includes a display panel and a display panel driver. The display panel includes gate lines, data lines, emission lines, and pixels. The display panel driver includes a gate driver for providing a gate signal to the gate lines, a data driver for providing a data voltage to the data lines, an emission driver for providing an emission signal to the emission lines, and a driving controller for controlling the gate driver, the data driver, and the emission driver.

The gate driver may include a plurality of stages, and the stages may sequentially provide the gate signal to the pixels row by row. The gate signal may be generated by a gate output circuit included in each of the stages. Transistors included in the gate output circuit may be large. Therefore, the swing width of the gate signal is large, resulting in high power consumption of the gate driver.

### SUMMARY

Embodiments of the present inventive concept provide a gate driver for reducing a power consumption by reducing a swing width of a gate signal.

Embodiments of the present inventive concept provide a display device including the gate driver.

Embodiments of the present inventive concept provide an electronic device including the display device.

In an embodiment of a gate driver according to the present inventive concept, the gate driver includes a plurality of stages. Each of the stages comprises a control circuit configured to receive an input signal in response to a first clock signal and control a voltage of a control node and a voltage of an inverted control node based on the input signal, a carry output circuit configured to output a high gate voltage or a second clock signal as a carry signal in response to the voltage of the control node and the voltage of the inverted control node, and a gate output circuit configured to output the high gate voltage or a gate clock signal as a gate signal in response to the voltage of the control node and the voltage of the inverted control node.

In an embodiment, the second clock signal may have a swing width between the high gate voltage and a first low gate voltage, and the gate signal may have a swing width between the high gate voltage and a second low gate voltage different from the first low gate voltage.

In an embodiment, the first low gate voltage may be lower than the second low gate voltage.

In an embodiment, the carry output circuit may include a sixth transistor including a gate electrode connected to the inverted control node, a first electrode receiving the high gate voltage, and a second electrode connected to a carry output node from which the carry signal is output, and a seventh transistor including a gate electrode connected to the control node, a first electrode receiving the second clock signal, and a second electrode connected to the carry output node.

In an embodiment, that the carry output circuit may further include a first capacitor including a first electrode connected to the control node and a second electrode connected to the carry output node.

In an embodiment, the carry output circuit may further include a second capacitor including a first electrode receiving the high gate voltage and a second electrode connected to the inverted control node.

In an embodiment, the gate output circuit may include a first gate output transistor including a gate electrode connected to the inverted control node, a first electrode receiving the high gate voltage, and a second electrode connected to a gate output node, and a second gate output transistor including a gate electrode connected to the control node, a first electrode receiving the gate clock signal, and a second electrode connected to the gate output node.

In an embodiment, the control circuit may include a first transistor including a gate electrode receiving the first clock signal, a first electrode receiving the input signal, and a second electrode connected to the control node, a second transistor including a gate electrode connected to the inverted control node, a first electrode receiving the high gate voltage, and a second electrode, a fourth transistor including a gate electrode connected to the control node, a first electrode receiving the first clock signal, and a second electrode connected to the inverted control node, and a fifth transistor including a gate electrode receiving the first clock signal, a first electrode receiving a first low gate voltage, and a second electrode connected to the inverted control node.

In an embodiment, the control circuit may further include a third transistor including a gate electrode receiving the gate clock signal, a first electrode connected to the control node, and a second electrode connected to the second electrode of the second transistor.

In an embodiment, the control circuit may further include a third transistor including a gate electrode receiving the second clock signal, a first electrode connected to the control node, and a second electrode connected to the second electrode of the second transistor.

In an embodiment, the control node may include a first control node and a second control node, and the control circuit may further include an eighth transistor including a gate electrode receiving a first low gate voltage, a first electrode connected to the first control node, and a second electrode connected to the second control node.

In an embodiment of a display device according to the present inventive concept, the display device comprises a display panel including a plurality of pixels, a gate driver configured to apply a gate signal to the pixels. The gate driver includes a plurality of stages. Each of the stages comprises a control circuit configured to receive an input signal in response to a first clock signal and control a voltage of a control node and a voltage of an inverted control node based on the input signal, a carry output circuit configured to output a high gate voltage or a second clock signal as a carry signal in response to the voltage of the control node and the voltage of the inverted control node, and a gate output circuit configured to output the high gate voltage or a gate clock signal as a gate signal in response to the voltage of the control node and the voltage of the inverted control node.

In an embodiment, the second clock signal may have a swing width between the high gate voltage and a first low gate voltage, and the gate signal may have a swing width between the high gate voltage and a second low gate voltage different from the first low gate voltage.

In an embodiment, the first low gate voltage may be lower than the second low gate voltage.

In an embodiment, the carry output circuit may include a sixth transistor including a gate electrode connected to the inverted control node, a first electrode receiving the high gate voltage, and a second electrode connected to a carry output node from which the carry signal is output, and a seventh transistor including a gate electrode connected to the control node, a first electrode receiving the second clock signal, and a second electrode connected to the carry output node.

In an embodiment, the carry output circuit may further include a first capacitor including a first electrode connected to the control node and a second electrode connected to the carry output node.

In an embodiment, the carry output circuit may further include a second capacitor including a first electrode receiving the high gate voltage and a second electrode connected to the inverted control node.

In an embodiment, the gate output circuit may include a first gate output transistor including a gate electrode connected to the inverted control node, a first electrode receiving the high gate voltage, and a second electrode connected to a gate output node, and a second gate output transistor including a gate electrode connected to the control node, a first electrode receiving the gate clock signal, and a second electrode connected to the gate output node.

In an embodiment, the control circuit may include a first transistor including a gate electrode receiving the first clock signal, a first electrode receiving the input signal, and a second electrode connected to the control node, a second transistor including a gate electrode connected to the inverted control node, a first electrode receiving the high gate voltage, and a second electrode, a fourth transistor including a gate electrode connected to the control node, a first electrode receiving the first clock signal, and a second electrode connected to the inverted control node, and a fifth transistor including a gate electrode receiving the first clock signal, a first electrode receiving a first low gate voltage, and a second electrode connected to the inverted control node.

In an embodiment, the control circuit may further include a third transistor including a gate electrode receiving the gate clock signal, a first electrode connected to the control node, and a second electrode connected to the second electrode of the second transistor.

In an embodiment of an electronic device according to the present inventive concept, the electronic device comprises a display panel including a plurality of pixels, a gate driver configured to apply a gate signal to the pixels, and a power supply configured to apply a power to the display panel and the gate driver. The gate driver includes a plurality of stages. Each of the stages comprises a control circuit configured to receive an input signal in response to a first clock signal and control a voltage of a control node and a voltage of an inverted control node based on the input signal, a carry output circuit configured to output a high gate voltage or a second clock signal as a carry signal in response to the voltage of the control node and the voltage of the inverted control node, and a gate output circuit configured to output the high gate voltage or a gate clock signal as a gate signal in response to the voltage of the control node and the voltage of the inverted control node.

According to the gate driver, the display device including the gate driver, and the electronic device including the display device, a swing width of a gate signal between a high gate voltage and a second low gate voltage may be less than a swing width of a carry signal between the high gate voltage and a first low gate voltage. Accordingly, since the swing width of the gate signal is small, a power consumption of the gate driver may be small.

### BRIEF DESCRIPTION OF THE DRAWINGS

The above and other features of embodiments of the present inventive concept will become more apparent by describing in detailed embodiments thereof with reference to the accompanying drawings, in which:

FIG. 1 is a block diagram showing a display device according to embodiments of the present inventive concept;

FIG. 2 is a circuit diagram showing an example of a pixel of FIG. 1;

FIG. 3 is a block diagram showing a gate driver according to embodiments of the present inventive concept;

FIG. 4 is a timing diagram showing an example of an operation of a gate driver of FIG. 3;

FIG. 5 is a circuit diagram showing an example of a stage included in a gate driver of FIG. 3;

FIG. 6 is a timing diagram showing an example of an operation of a stage of FIG. 5;

FIG. 7 is a circuit diagram showing an example of an operation of a stage of FIG. 5 in a first time period of FIG. 6;

FIG. 8 is a circuit diagram showing an example of an operation of a stage of FIG. 5 in a second time period of FIG. 6;

FIG. 9 is a circuit diagram showing an example of an operation of a stage of FIG. 5 in a third time period of FIG. 6;

FIG. 10 is a circuit diagram showing an example of an operation of a stage of FIG. 5 in a fourth time period of FIG. 6;

FIG. 11 is a circuit diagram showing an example of a stage included in the gate driver of FIG. 3;

FIG. 12 is a block diagram showing an electronic device; and

FIG. 13 is a diagram showing an embodiment in which an electronic device of FIG. 12 is implemented as a smart phone.

### DETAILED DESCRIPTION OF THE EMBODIMENTS

Hereinafter, the present inventive concept will be described in more detail with reference to the accompanying drawings.

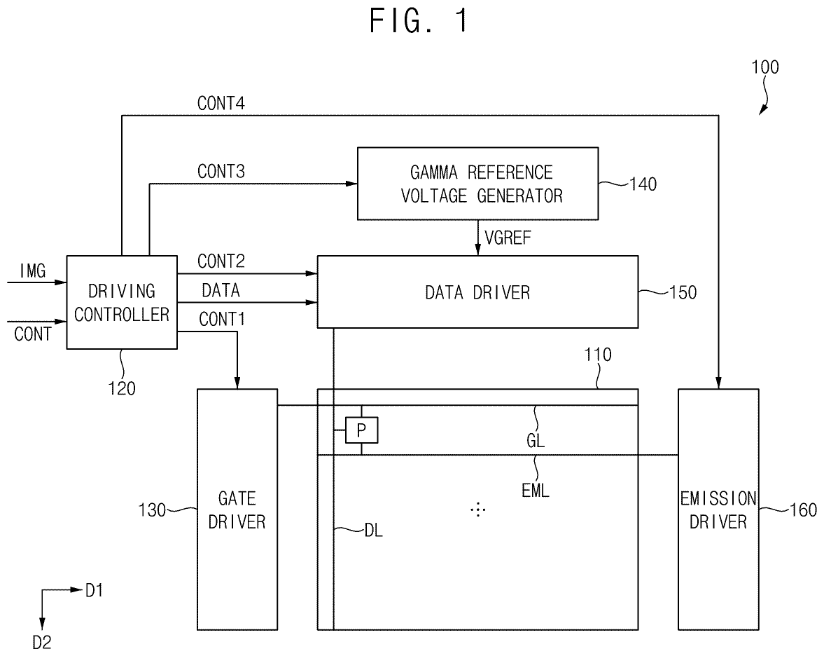

FIG. 1 is a block diagram showing a display device 100 according to embodiments of the present inventive concept.

Referring to FIG. 1, a display device 100 may include a display panel 110 and a display panel driver. The display panel driver may include a driving controller 120, a gate driver 130, a gamma reference voltage generator 140, a data driver 150, and an emission driver 160.

The display panel 110 may include a display area for displaying an image and a peripheral area disposed adjacent to the display area.

The display panel 110 may include gate lines GL, data lines DL, emission lines EML, and pixels P electrically connected to the gate lines GL, the data lines DL, and the emission lines EML, respectively. The gate lines GL may extend in a first direction D1, the data lines DL may extend in a second direction D1 crossing the first direction D1, and the emission lines EML may extend in the first direction D1.

The driving controller 120 may receive input image data IMG and an input control signal CONT from an external device. For example, the input image data IMG may include red image data, green image data and blue image data. The input image data IMG may include white image data. The input image data IMG may include magenta image data, yellow image data, and cyan image data. The input control signal CONT may include a master clock signal and a data enable signal. The input control signal CONT may further include a vertical synchronization signal and a horizontal synchronization signal.

The driving controller 120 may generate a first control signal CONT1, a second control signal CONT2, a third control signal CONT3, a fourth control signal CONT4, and a data signal DATA based on the input image data IMG and the input control signal CONT.

The driving controller 120 may generate the first control signal CONTI for controlling an operation of the gate driver 130 based on the input control signal CONT, and output the first control signal CONT1 to the gate driver 130. The first control signal CONT1 may include a vertical start signal and a gate clock signal.

The driving controller 120 may generate the second control signal CONT2 for controlling an operation of the data driver 150 based on the input control signal CONT, and output the second control signal CONT2 to the data driver 150. The second control signal CONT2 may include a horizontal start signal and a load signal.

The driving controller 120 may generate the data signal DATA based on the input image data IMG. The driving controller 120 may output the data signal DATA to the data driver 150.

The driving controller 120 may generate the third control signal CONT3 for controlling an operation of the gamma reference voltage generator 140 based on the input control signal CONT, and output the third control signal CONT3 to the gamma reference voltage generator 140.

The driving controller 120 may generate the fourth control signal CONT4 for controlling an operation of the emission driver 160 based on the input control signal CONT, and output the fourth control signal CONT4 to the emission driver 160.

The gate driver 130 may generate gate signals for driving the gate lines GL in response to the first control signal CONT1 received from the driving controller 120. The gate driver 130 may output the gate signals to the gate lines GL.

The gamma reference voltage generator 140 may generate a gamma reference voltage VGREF in response to the third control signal CONT3 received from the driving controller 120. The gamma reference voltage generator 140 may provide the gamma reference voltage VGREF to the data driver 150. The gamma reference voltage VGREF may have a value corresponding to each data signal DATA.

For example, the gamma reference voltage generator 140 may be disposed in the driving controller 120 or may be disposed in the data driver 150.

The data driver 150 may receive the second control signal CONT2 and the data signal DATA from the driving controller 120, and receive the gamma reference voltage VGREF from the gamma reference voltage generator 140. The data driver 150 may convert the data signal DATA into a data voltage having an analog type using the gamma reference voltage VGREF. The data driver 150 may output the data voltage to the data line DL.

The emission driver 160 may generate emission signals for driving the emission lines EML in response to the fourth control signal CONT4 received from the driving controller 120. The emission driver 160 may output the emission signals to the emission lines EML.

In FIG. 1, for a convenience of an explanation, the gate driver 130 may be disposed on a first side of the display panel 110 and the emission driver 160 may be disposed on a second side of the display panel 110. Although shown, the present inventive concept is not limited thereto. For example, both the gate driver 130 and the emission driver 160 may be disposed on the first side of the display panel 110. For example, both the gate driver 130 and the emission driver 160 may be disposed on both sides of the display panel 100. For example, the gate driver 130 and the emission driver 160 may be formed integrally.

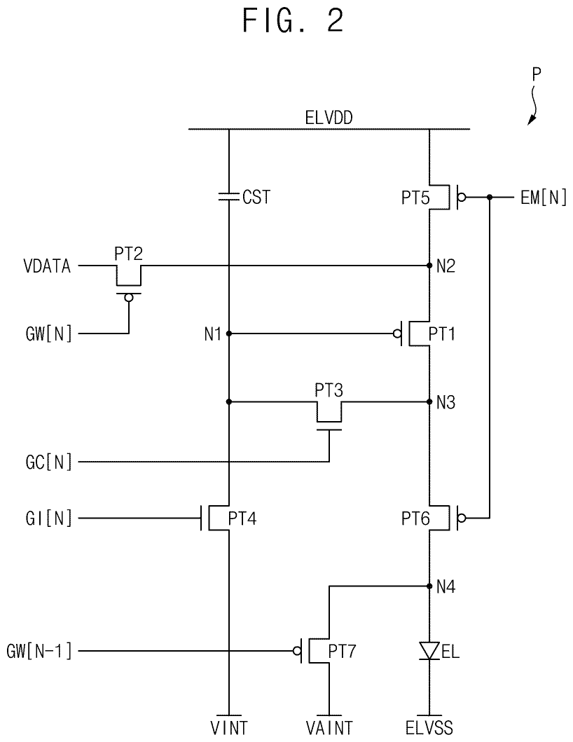

FIG. 2 is a circuit diagram showing an example of a pixel P of FIG. 1.

Referring to FIGS. 1 and 2, the pixel P may include first to seventh pixel transistors PT1 to PT7, a storage capacitor CST, and a light emitting element EL.

The first pixel transistor PT1 may include a gate electrode connected to a first node N1, a first electrode connected to a second node N2, and a second electrode connected to a third node N3. The first pixel transistor PT1 may generate a driving current based on a difference between a voltage of the first node N1 and a voltage of the second node N2.

The second pixel transistor PT2 may include a gate electrode receiving a data write gate signal GW[N], a first electrode receiving a data voltage VDATA, and a second electrode connected to the second node N2. (Here, N is a positive integer greater than or equal to 2.) The second pixel transistor PT2 may provide the data voltage VDATA to the second node N2 in response to the data write gate signal GW[N].

The third pixel transistor PT3 may include a gate electrode receiving a compensation gate signal GC[N], a first electrode connected to the third node N3, and a second electrode connected to the first node N1. The third pixel transistor PT3 may diode-connect the first pixel transistor PT1 in response to the compensation gate signal GC[N].

The fourth pixel transistor PT4 may include a gate electrode receiving an initialization gate signal GI[N], a first electrode receiving an initialization voltage VINT, and a second electrode connected to the first node N1. The fourth pixel transistor PT4 may provide the initialization voltage VINT to the first node N1 in response to the initialization gate signal GI[N].

The fifth pixel transistor PT5 may include a gate electrode receiving an emission signal EM[N], a first electrode receiving a first power voltage ELVDD, and a second electrode connected to the second node N2. The sixth pixel transistor PT6 may include a gate electrode receiving the emission signal EM[N], a first electrode connected to the third node N3, and a second electrode connected to a fourth node N4. The fifth pixel transistor PT5 and the sixth pixel transistor PT6 may control a light emission of the light emitting element EL in response to the emission signal EM.

The seventh pixel transistor PT7 may include a gate electrode receiving a previous data write gate signal GW[N-1], a first electrode receiving an anode initialization voltage VAINT, and a second electrode connected to the fourth node N4. The seventh pixel transistor PT7 may provide the anode initialization voltage VAINT to the fourth node N4 in response to the previous data write gate signal GW[N-1].

The storage capacitor CST may include a first electrode receiving the first power voltage ELVDD and a second electrode connected to the first node N1. The storage capacitor CST may store the data voltage VDATA.

The light emitting element EL may include an anode connected to the fourth node N4 and a cathode receiving a second power voltage ELVSS. The light emitting element EL may emit light based on the driving current. Since an intensity of the driving current is determined based on a level of the data voltage VDATA, an emission intensity of the light emitting element EL may be determined based on the level of the data voltage VDATA.

Here, [N] may mean a current stage, and [N-1] may mean a previous stage.

In an embodiment, the first, second, and fifth to seventh pixel transistors PT1, PT2, PT5 to PT7 may be P-type transistors, and the third and fourth pixel transistors PT3, PT4 may be N-type transistors. For example, the P-type transistor may be a PMOS (P-type Metal Oxide Semiconductor) transistor. For example, the N-type transistor may be an NMOS (N-type Metal Oxide Semiconductor) transistor. However, the present inventive concept is not limited thereto. The first to seventh pixel transistors PT1 to PT7 may be P-type transistors. Alternatively, the first to seventh pixel transistors PT1 to PT7 may be the N-type transistors.

In addition, although the pixel P in FIG. 2 is shown as including seven transistors (PT1 to PT7) and one capacitor (CST), the present inventive concept is not limited thereto. The pixel P may include at least two or more transistors or at least one or more capacitors.

Meanwhile, for example, a data range, which is a range of the data voltage VDATA, may be 1 V to 7 V, a swing width of the data write gate signal GW[N] may be −8 V to 8 V, and a threshold voltage of the second pixel transistor PT2 may be −2 V. In this case, a swing width of a gate-source voltage of the second pixel transistor PT2 may be −7 V to 15 V. Therefore, a margin of the gate-source voltage of the second pixel transistor PT2 for turning on the second pixel transistor PT2 may be 5 V. Accordingly, in order to reduce a power consumption of a stage for outputting the data write gate signal GW[N], the swing width of the data write gate signal GW[N] may be required to be reduced.

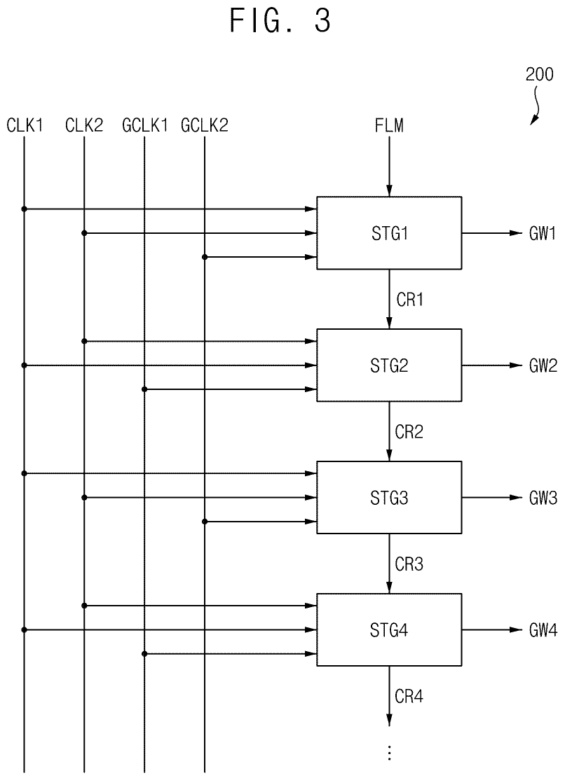

FIG. 3 is a block diagram showing a gate driver 200 according to embodiments of the present inventive concept.

Referring to FIGS. 1 to 3, a gate driver 200 according to embodiments of the present inventive concept may include a plurality of stages STG1, STG2, STG3, STG4, . . .

The stages STG1, STG2, STG3, STG4, . . . may receive a gate start signal FLM, a first clock signal CLK1, a second clock signal CLK2, a first gate clock signal GCLK1, and a second gate clock signal GCLK2.

Each of the stages STG1, STG2, STG3, STG4, . . . may alternately receive the first clock signal CLK1 and the second clock signal CLK2. For example, a first clock terminal of a first stage STG1 may receive the first clock signal CLK1, and a second clock terminal of the first stage STG1 may receive the second clock signal CLK2. For example, a first clock terminal of a second stage STG2 may receive the second clock signal CLK2, and a second clock terminal of the second stage STG2 may receive the first clock signal CLK1. For example, a first clock terminal of a third stage STG3 may receive the first clock signal CLK1, and a second clock terminal of the third stage STG3 may receive the second clock signal CLK2. For example, the first clock terminal of a fourth stage STG4 may receive the second clock signal CLK2, and a second clock terminal of the fourth stage STG4 may receive the first clock signal CLK1.

Each of the first gate clock signal GCLK1 and the second gate clock signal GCLK2 may be alternately applied to each of the stages STG1, STG2, STG3, STG4, . . . . For example, the second gate clock signal GCLK2 may be applied to a gate clock terminal of the first stage STG1. For example, the first gate clock signal GCLK1 may be applied to a gate clock terminal of the second stage STG2. For example, the second gate clock signal GCLK2 may be applied to a gate clock terminal of the third stage STG3. For example, the first gate clock signal GCLK1 may be applied to a gate clock terminal of the fourth stage STG4.

An input terminal of the first stage STG1 may receive the gate start signal FLM, and an input terminal of each of subsequent stages STG2, STG3, STG4, . . . may receive a carry signal of a previous stage. For example, an input terminal of the second stage STG2 may receive a first carry signal CR1 of the first stage STG1. For example, the third stage STG3 may receive a second carry signal CR2 of the second stage STG2. For example, the fourth stage STG4 may receive a third carry signal CR3 of the third stage STG3.

The stages STG1, STG2, STG3, STG4, . . . may sequentially generate carry signals CR1, CR2, CR3, CR4, . . . and gate signals GW1, GW2, GW3, GW4, . . . in units of rows based on the gate start signal FLM, the first clock signal CLK1, the second clock signal CLK2, the first gate clock signal GCLK1, and the second gate clock signal GCLK2. For example, a carry output terminal of the first stage STG1 may output the first carry signal CR1, and a gate output terminal of the first stage STG1 may output a first gate signal GW1. For example, a carry output terminal of the second stage STG2 may output the second carry signal CR2, and a gate output terminal of the second stage STG2 may output a second gate signal GW2. For example, a carry output terminal of the third stage STG3 may output the third carry signal CR3, and a gate output terminal of the third stage STG3 may output a third gate signal GW3. For example, a carry output terminal of the fourth stage STG4 may output the fourth carry signal CR4, and a gate output terminal of the fourth stage STG4 may output a fourth gate signal GW4.

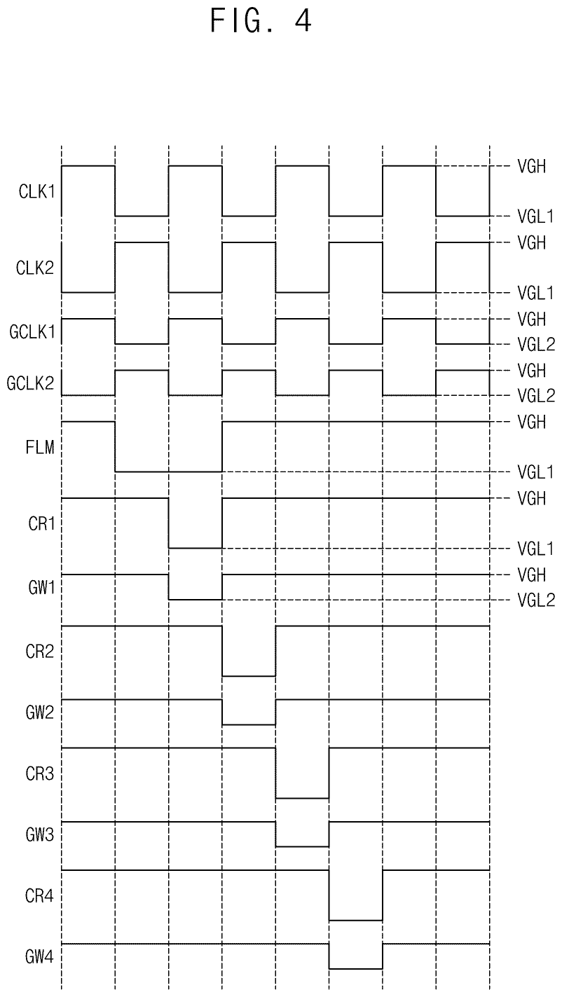

FIG. 4 is a timing diagram showing an example of an operation of a gate driver 200 of FIG. 3.

Referring to FIGS. 1 to 4, the first clock signal CLK1 and the second clock signal CLK2 may have different phases. For example, the first clock signal CLK1 and the second clock signal CLK2 may have opposite phases. The first clock signal CLK1 and the second clock signal CLK2 may have a swing width between a high gate voltage VGH and a first low gate voltage VGL1. For example, the high gate voltage VGH may be 8 V, and the first low gate voltage VGL1 may be −8 V.

The first gate clock signal GCLK1 and the second gate clock signal GCLK2 may have different phases. For example, the first gate clock signal GCLK1 and the second gate clock signal GCLK2 may have opposite phases. The first gate clock signal GCLK1 and the second gate clock signal GCLK2 may have a swing width between the high gate voltage VGH and the second low gate voltage VGL2. In an embodiment, the second low gate voltage VGL2 may be higher than the first low gate voltage VGL1. For example, the second low gate voltage VGL2 may be −4 V. Therefore, the swing width of the first clock signal CLK1 and the swing width of the second clock signal CLK2 may be greater than a swing width of the first gate clock signal GCLK1 and a swing width of the second gate clock signal GCLK2.

The gate start signal FLM may have the swing width between the high gate voltage VGH and the first low gate voltage VGL1.

The first stage STG1 may receive the gate start signal FLM having the first low gate voltage VGL1 in response to the first clock signal CLK1 having the first low gate voltage VGL1. The first stage STG1 may generate the second clock signal CLK2 having the first low gate voltage VGL1 as the first carry signal CR1 based on the gate start signal FLM having the first low gate voltage VGL1. The first stage STG1 may generate the second gate clock signal GCLK2 having the second low gate voltage VGL2 as the first gate signal GW1 based on the gate start signal FLM having the first low gate voltage VGL1.

The second stage STG2 may receive the first carry signal CR1 having the first low gate voltage VGL1 in response to the second clock signal CLK2 having the first low gate voltage VGL1. The second stage STG2 may generate the first clock signal CLK1 having the first low gate voltage VGL1 as the second carry signal CR2 based on the first carry signal CR1 having the first low gate voltage VGL1. The second stage STG2 may generate the first gate clock signal GCLK1 having the second low gate voltage VGL2 as the second gate signal GW2 based on the first carry signal CR1 having the first low gate voltage VGL1.

The third stage STG3 may receive the second carry signal CR2 having the first low gate voltage VGL1 in response to the first clock signal CLK1 having the first low gate voltage VGL1. The third stage STG3 may generate the first clock signal CLK1 having the first low gate voltage VGL1 as the third carry signal CR3 based on the second carry signal CR2 having the first low gate voltage VGL1. The third stage STG3 may generate the second gate clock signal GCLK2 having the second low gate voltage VGL2 as the third gate signal GW3 based on the second carry signal CR2 having the first low gate voltage VGL1.

The fourth stage STG4 may receive the third carry signal CR3 having the first low gate voltage VGL1 in response to the second clock signal CLK2 having the first low gate voltage VGL1. The fourth stage STG4 may generate the second clock signal CLK2 having the first low gate voltage VGL1 as the fourth carry signal CR4 based on the third carry signal CR3 having the first low gate voltage VGL1. The fourth stage STG4 may generate the first gate clock signal GCLK1 having the second low gate voltage VGL2 as the fourth gate signal GW4 based on the third carry signal CR3 having the first low gate voltage VGL1.

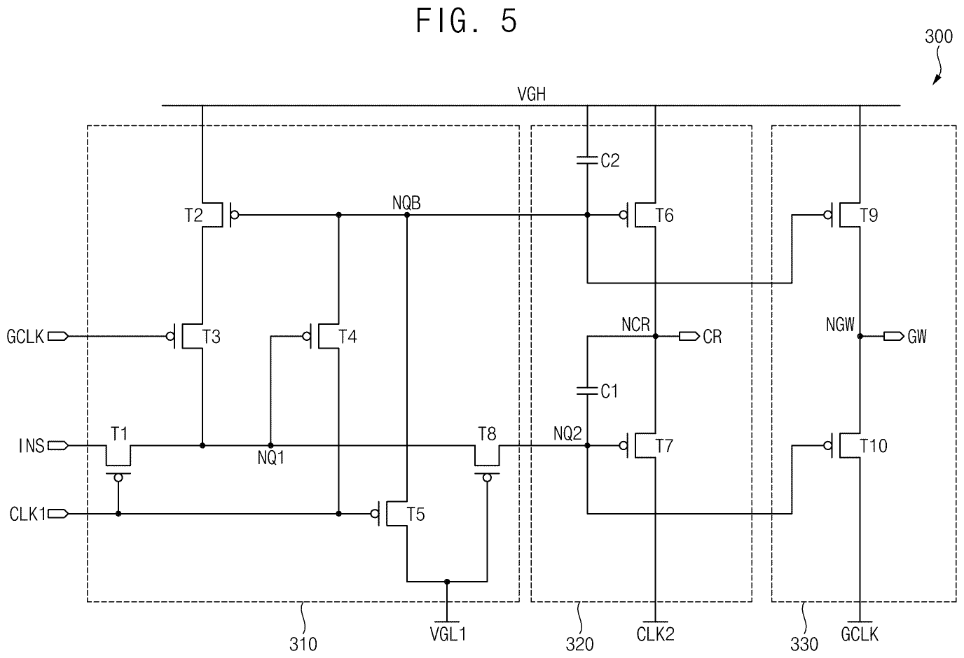

FIG. 5 is a circuit diagram showing an example of a stage 300 included in a gate driver 200 of FIG. 3.

Referring to FIGS. 1 to 5, a stage 300 may include a control circuit 310, a carry output circuit 320, and a gate output circuit 330.

The control circuit 310 may receive an input signal INS in response to a first clock signal CLK1, and may control voltages of control nodes NQ1, NQ2 and a voltage of an inverted control node NQB based on the input signal INS. The input signal INS may be a gate start signal FLM or a carry signal of a previous stage. The control nodes NQ1, NQ2 may herein be collectively referred to as a “control node.”

The control circuit 310 may include a first transistor T1, a second transistor T2, a third transistor T3, a fourth transistor T4, and a fifth transistor T5.

The first transistor T1 may include a gate electrode receiving the first clock signal CLK1, a first electrode receiving the input signal INS, and a second electrode connected to the control node NQ1, NQ2.

The second transistor T2 may include a gate electrode connected to the inverted control node NQB, a first electrode receiving a high gate voltage VGH, and a second electrode.

The third transistor T3 may include a gate electrode receiving a gate clock signal GCLK, a first electrode connected to the control node NQ1, NQ2, and a second electrode connected to the second electrode of the second transistor T2.

The fourth transistor T4 may include a gate electrode connected to the control node NQ1, NQ2, a first electrode receiving the first clock signal CLK1, and a second electrode connected to the inverted control node NQB.

The fifth transistor T5 may include a gate electrode receiving the first clock signal CLK1, a first electrode receiving a first low gate voltage VGL1, and a second electrode connected to the inverted control node NQB.

The control node NQ1, NQ2 may include a first control node NQ1 and a second control node NQ2, and the control circuit 310 may further include an eighth transistor T8.

The eighth transistor T8 may include a gate electrode receiving the first low gate voltage VGL1, a first electrode connected to the first control node NQ1, and a second electrode connected to the second control node NQ2.

The carry output circuit 320 may include a sixth transistor T6 and a seventh transistor T7.

The sixth transistor T6 may include a gate electrode connected to the inverted control node NQB, a first electrode receiving the high gate voltage VGH, and a second electrode connected to a carry output node NCR. A carry signal CR may be output from the carry output node NCR.

The seventh transistor T7 may include a gate electrode connected to the control node NQ1, NQ2, a first electrode receiving a second clock signal CLK2, and a second electrode connected to the carry output node NCR.

The carry output circuit 320 may further include a first capacitor C1.

The first capacitor C1 may include a first electrode connected to the control node NQ1, NQ2 and a second electrode connected to the carry output node NCR.

The carry output circuit 320 may further include a second capacitor C2.

The second capacitor C2 may include a first electrode receiving the high gate voltage VGH and a second electrode connected to the inverted control node NQB.

The gate output circuit 330 may include a ninth transistor T9 and a tenth transistor T10. The ninth transistor T9 and the tenth transistor T10 may herein be referred to as “a first gate output transistor” and “a second gate output transistor,” respectively.

The ninth transistor T9 may include a gate electrode connected to the inverted control node NQB, a first electrode receiving the high gate voltage VGH, and a second electrode connected to a gate output node NGW. A gate signal GW may be output from the gate output node NGW.

The tenth transistor T10 may include a gate electrode connected to the control node NQ1, NQ2, a first electrode receiving the gate clock signal GCLK, and a second electrode connected to the gate output node NGW.

In an embodiment, the first to tenth pixel transistors PT1 to PT10 may be P-type transistors. For example, the P-type transistors may be PMOS transistors. However, the present inventive concept is not limited thereto.

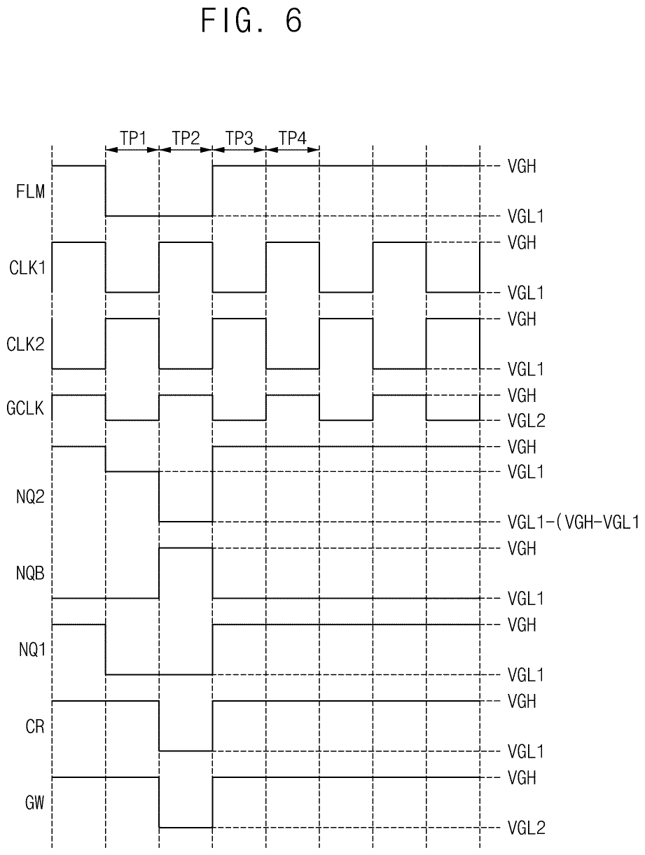

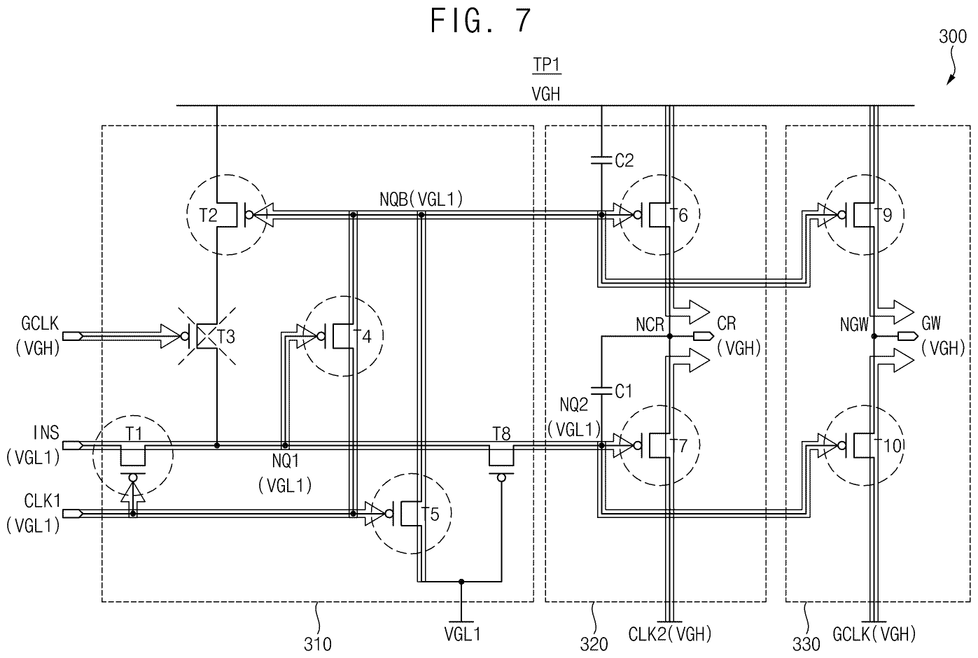

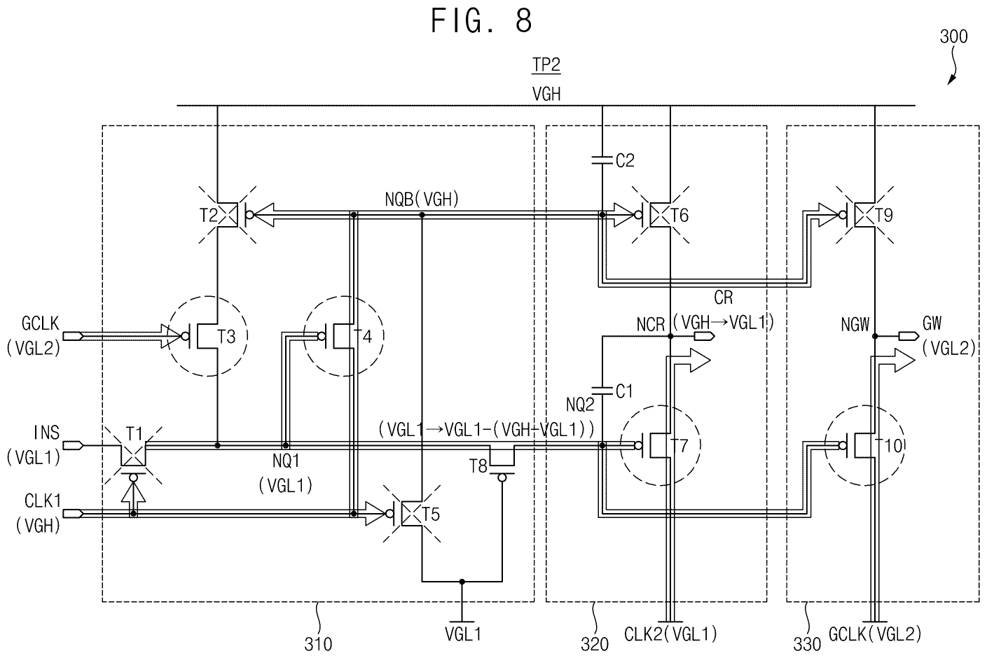

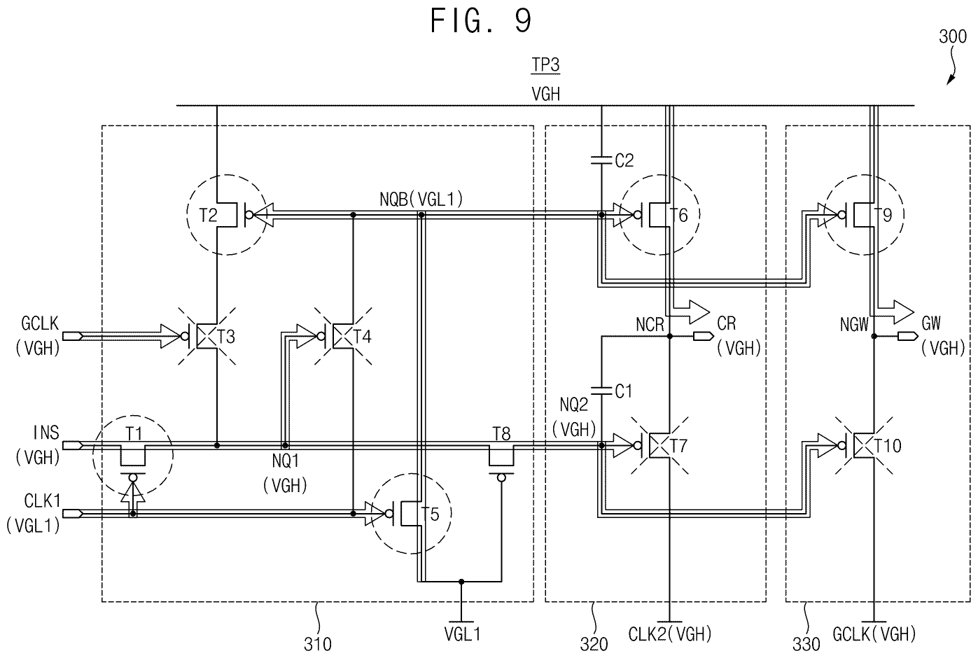

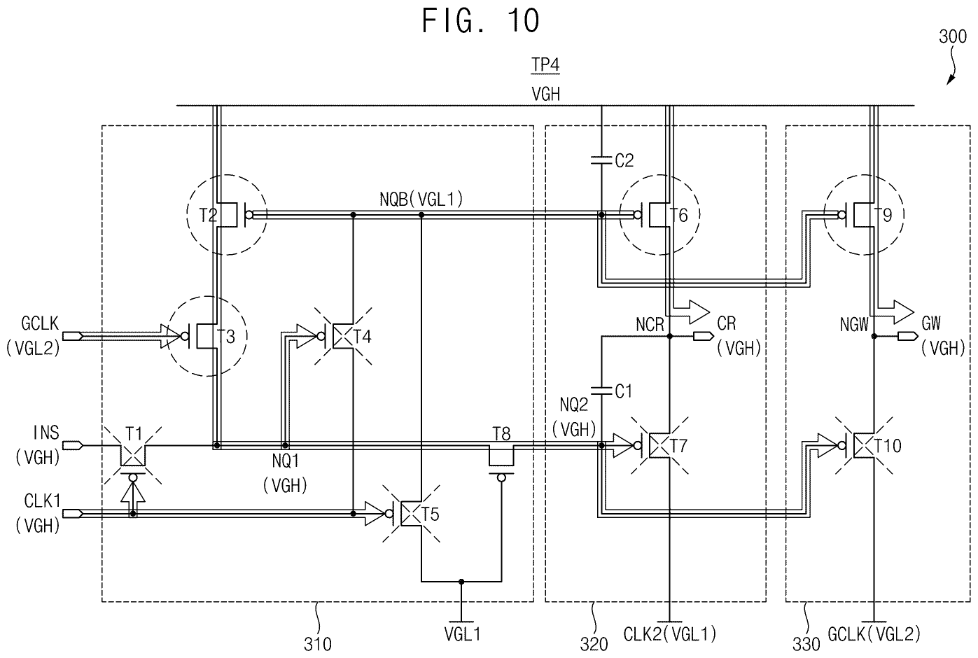

FIG. 6 is a timing diagram showing an example of an operation of a stage 300 of FIG. 5. FIG. 7 is a circuit diagram showing an example of an operation of a stage 300 of FIG. 5 in a first time period TP1 of FIG. 6. FIG. 8 is a circuit diagram showing an example of an operation of a stage 300 of FIG. 5 in a second time period TP2 of FIG. 6. FIG. 9 is a circuit diagram showing an example of an operation of a stage 300 of FIG. 5 in a third time period TP3 of FIG. 6. FIG. 10 is a circuit diagram showing an example of an operation of a stage 300 of FIG. 5 in a fourth time period TP4 of FIG. 6.

Referring to FIGS. 1 to 9, the stage 300 may generate the carry signal CR and the gate signal GW based on the input signal INS, the first clock signal CLK1, the second clock signal CLK2, and the gate clock signal GCLK. FIGS. 6 to 10 show a case where the input signal INS is the gate start signal FLM. However, the present inventive concept is not limited thereto. FIGS. 6 to 10 may also be applied to a case where the input signal INS is the carry signal of the previous stage.

As shown in FIG. 6, in a first time period TP1, the input signal INS may have the first low gate voltage VGL1, the first clock signal CLK1 may have the first low gate voltage VGL1, and the second clock signal CLK2 may have the high gate voltage VGH.

As shown in FIG. 7, the first transistor T1 may be turned on in response to the first clock signal CLK1 having the first low gate voltage VGL1 and may provide the input signal INS having the first low gate voltage VGL1 to the first control node NQ1. Therefore, a voltage of the first control node NQ1 may be the first low gate voltage VGL1.

The eighth transistor T8 may be turned on in response to the first low gate voltage VGL1 and may provide the voltage of the first control node NQ1 to the second control node NQ2. Therefore, a voltage of the second control node NQ2 may be the first low gate voltage VGL1.

The fourth transistor T4 may be turned on in response to the voltage of the first control node NQ1, which is the first low gate voltage VGL1, and may provide the first clock signal CLK1 having the first low gate voltage VGL1 to the inverted control node NQB. Therefore, a voltage of the inverted control node NQB may be the first low gate voltage VGL1. Since a voltage of the first electrode of the second capacitor C2 is the high gate voltage VGH and a voltage of the second electrode of the second capacitor C2 is the first low gate voltage VGL1, the second capacitor C2 may be precharged.

The fifth transistor T5 may be turned on in response to the first clock signal CLK1 having the first low gate voltage VGL1 and may provide the first low gate voltage VGL1 to the inverted control node NQB. Therefore, the voltage of the inverted control node NQB may be the first low gate voltage VGL1.

The second transistor T2 may be turned on in response to the voltage of the inverted control node NQB which is the first low gate voltage VGL1 and may provide the high gate voltage VGH to the second electrode of the third transistor T3.

The third transistor T3 may be turned off in response to the gate clock signal GCLK having the high gate voltage VGH.

The sixth transistor T6 may be turned on in response to the voltage of the inverted control node NQB, which is the first low gate voltage VGL1, and may provide the high gate voltage VGH to the carry output node NCR. Therefore, a carry signal CR having the high gate voltage VGH may be output from the carry output node NCR. Since the voltage of the first electrode of the first capacitor C1 is the first low gate voltage VGL1 and the voltage of the second electrode of the first capacitor C1 is the high gate voltage VGH, the first capacitor C1 may be precharged.

The seventh transistor T7 may be turned on in response to the voltage of the second control node NQ2 which is the first low gate voltage VGL1 and may provide the second clock signal CLK2 having the high gate voltage VGH to the carry output node NCR. Therefore, the carry signal CR having the high gate voltage VGH may be output from the carry output node NCR.

The ninth transistor T9 may be turned on in response to the voltage of the inverted control node NQB which is the first low gate voltage VGL1 and may provide the high gate voltage VGH to the gate output node NGW. Therefore, the gate signal GW having the high gate voltage VGH may be output from the gate output node NGW.

The tenth transistor T10 may be turned on in response to the voltage of the second control node NQ2, which is the first low gate voltage VGL1, and may provide the gate clock signal GCLK having the high gate voltage VGH to the gate output node NGW. Therefore, the gate signal GW having the high gate voltage VGH may be output from the gate output node NGW.

As such, in the first time period TP1, the voltage of the first control node NQ1 and the voltage of the second control node NQ2 may be controlled based on the input signal INS having the first low gate voltage VGL1, the first capacitor C1 and the second capacitor C2 may be precharged, and the carry signal CR having the high gate voltage VGH and the gate signal GW having the high gate voltage VGH may be generated based on the voltage of the second control node NQ2 and the voltage of the inverted control node NQB.

As shown in FIG. 6, in a second time period TP2, the input signal INS may have the first low gate voltage VGL1, the first clock signal CLK1 may have the high gate voltage VGH, and the second clock signal CLK2 may have the first low gate voltage VGL1.

As shown in FIG. 8, the first transistor T1 and the fifth transistor T5 may be turned off in response to the first clock signal CLK1 having the high gate voltage VGH, and the eighth transistor T8 may be turned on in response to the first low gate voltage VGL1. Therefore, the voltage of the first control node NQ1 and the voltage of the second control node NQ2 may be maintained at the first low gate voltage VGL1, which is a previous voltage, by the first capacitor C1.

The fourth transistor T4 may be turned on in response to the voltage of the first control node NQ1 which is the first low gate voltage VGL1 and may provide the first clock signal CLK1 having the high gate voltage VGH to the inverted control node NQB. Therefore, the voltage of the inverted control node NQB may be the high gate voltage VGH. Since the voltage of the first electrode of the second capacitor C2 is the high gate voltage VGH and the voltage of the second electrode of the second capacitor C2 is the high gate voltage VGH, the second capacitor C2 may be discharged.

The second transistor T2 may be turned off in response to the high gate voltage VGH. The third transistor T3 may be turned on in response to a gate clock signal GCLK having the second low gate voltage VGL2 and may provide the voltage of the first control node NQ1, which is the first low gate voltage VGL1, to the second electrode of the second transistor T2.

The sixth transistor T6 and the ninth transistor T9 may be turned off in response to the voltage of the inverted control node NQB, which is the high gate voltage VGH.

The seventh transistor T7 may be turned on in response to the voltage of the second control node NQ2 having the first low gate voltage VGL1 and may provide the second clock signal CLK2 having the first low gate voltage VGL1 to the carry output node NCR. Therefore, the carry signal CR having the first low gate voltage VGL1 may be output from the carry output node NCR.

Since a voltage of the carry output node NCR changes from the high gate voltage VGH to the first low gate voltage VGL1 by “VGH−VGL1”, the voltage of the second control node NQ2 may change from the first low gate voltage VGL1 by “VGH−VGL1” while a precharged voltage of the first capacitor C1 is maintained. That is, the voltage of the second control node NQ2 may be bootstrapped to “VGL1−(VGH−VGL1)”. Since the voltage of the second control node NQ2 is bootstrapped, the seventh transistor T7 may be turned on more stably.

Since the eighth transistor T8 is turned on in response to the first low gate voltage VGL1, the eighth transistor T8 may be an always-on transistor (AOT). Since the eighth transistor T8 is the always-on transistor and the P-type transistor, the eighth transistor T8 may prevent the bootstrapped voltage of the second control node NQ2 from being transferred to the first control node NQ1. Therefore, the voltage of the first control node NQ1 may be maintained at the first low gate voltage VGL1.

The tenth transistor T10 may be turned on in response to the voltage of the second control node NQ2 which is “VGL1−(VGH−VGL1)” and may provide the gate clock signal GCLK having the second low gate voltage VGL2 to the gate output node NGW. Therefore, the gate signal GW having the second low gate voltage VGL2 may be output from the gate output node NGW.

In this way, in the second time period TP2, the second capacitor C2 may be discharged, the voltage of the second control node NQ2 may be bootstrapped, and the carry signal CR having the first low gate voltage VGL1 and the gate signal GW having the second low gate voltage VGL2 may be generated based on the bootstrapped voltage of the second control node NQ2.

As shown in FIG. 6, in a third time period TP3, the input signal INS may have the high gate voltage VGH, the first clock signal CLK1 may have the first low gate voltage VGL1, and the second clock signal CLK2 may have the high gate voltage VGH.

As shown in FIG. 9, the first transistor T1 may be turned on in response to the first clock signal CLK1 having the first low gate voltage VGL1 and may provide the input signal INS having the high gate voltage VGH to the first control node NQ1. Therefore, the voltage of the first control node NQ1 may be the high gate voltage VGH.

The eighth transistor T8 may be turned on in response to the first low gate voltage VGL1 and may provide the voltage of the first control node NQ1 to the second control node NQ2. Therefore, the voltage of the second control node NQ2 may be the high gate voltage VGH.

The seventh transistor T7 and the tenth transistor T10 may be turned off in response to the voltage of the second control node NQ2 which is the high gate voltage VGH.

The fourth transistor T4 may be turned off in response to the voltage of the first control node NQ1 which is the high gate voltage VGH.

The fifth transistor T5 may be turned on in response to the first clock signal CLK1 having the first low gate voltage VGL1 and may provide the first low gate voltage VGL1 to the inverted control node NQB. Therefore, the voltage of the inverted control node NQB may be the first low gate voltage VGL1. Since the voltage of the first electrode of the second capacitor C2 is the high gate voltage VGH and the voltage of the second electrode of the second capacitor C2 is the first low gate voltage VGL1, the second capacitor C2 may be precharged.

The second transistor T2 may be turned on in response to the voltage of the inverted control node NQB which is the first low gate voltage VGL1, and may provide the high gate voltage VGH to the second electrode of the third transistor T3.

The third transistor T3 may be turned off in response to the gate clock signal GCLK having the high gate voltage VGH.

The sixth transistor T6 may be turned on in response to the voltage of the inverted control node NQB, which is the first low gate voltage VGL1, and may provide the high gate voltage VGH to the carry output node NCR. Therefore, the carry signal CR having the high gate voltage VGH may be output from the carry output node NCR. Since the voltage of the first electrode of the first capacitor C1 is the high gate voltage VGH and the voltage of the second electrode of the first capacitor C1 is the high gate voltage VGH, the first capacitor C1 may be discharged.

The ninth transistor T9 may be turned on in response to the voltage of the inverted control node NQB, which is the first low gate voltage VGL1, and may provide the high gate voltage VGH to the gate output node NGW. Therefore, the gate signal GW having the high gate voltage VGH may be output from the gate output node NGW.

As such, in the third time period TP3, the voltage of the first control node NQ1 and the voltage of the second control node NQ2 may be controlled based on the input signal INS having the high gate voltage VGH, the first capacitor C1 may be discharged, the second capacitor C2 may be precharged, and the carry signal CR having the high gate voltage VGH and the gate signal GW having the high gate voltage VGH may be generated based on the voltage of the inverted control node NQB.

As shown in FIG. 6, in a fourth time period TP4, the input signal INS may have the high gate voltage VGH, the first clock signal CLK1 may have the high gate voltage VGH, and the second clock signal CLK2 may have the first low gate voltage VGL1.

As shown in FIG. 10, the first transistor T1 and the fifth transistor T5 may be turned off in response to the first clock signal CLK1 having the high gate voltage VGH, and the eighth transistor T8 may be turned on in response to the first low gate voltage VGL1. Therefore, the voltage of the first control node NQ1 and the voltage of the second control node NQ2 may be maintained at the high gate voltage VGH, which is a previous voltage, by the first capacitor C1.

The seventh transistor T7 and the tenth transistor T10 may be turned off in response to the voltage of the second control node NQ2 which is the high gate voltage VGH.

The fourth transistor T4 may be turned off in response to the voltage of the first control node NQ1 which is the high gate voltage VGH. Therefore, the voltage of the inverted control node NQB may be maintained at the first low gate voltage VGL1 which is the previous voltage by the second capacitor C2.

The second transistor T2 may be turned on in response to the voltage of the inverted control node NQB which is the first low gate voltage VGL1, and the third transistor T3 may be turned on in response to the gate clock signal GCLK having the second low gate voltage VGL2. Therefore, the second transistor T2 and the third transistor T3 may provide the high gate voltage VGH to the first control node NQ1. Therefore, the voltage of the first control node NQ1 may be the high gate voltage VGH.

The sixth transistor T6 may be turned on in response to the voltage of the inverted control node NQB, which is the first low gate voltage VGL1, and may provide the high gate voltage VGH to the carry output node NCR. Therefore, the carry signal CR having the high gate voltage VGH may be output from the carry output node NCR. Since the voltage of the first electrode of the first capacitor C1 is the high gate voltage VGH and the voltage of the second electrode of the first capacitor C1 is the high gate voltage VGH, the first capacitor C1 may be discharged.

The ninth transistor T9 may be turned on in response to the voltage of the inverted control node NQB, which is the first low gate voltage VGL1, and may provide the high gate voltage VGH to the gate output node NGW. Therefore, the gate signal GW having the high gate voltage VGH may be output from the gate output node NGW.

As such, in the fourth time period TP4, the first capacitor C1 may be discharged, the second capacitor C2 may be precharged, and the carry signal CR having the high gate voltage VGH and the gate signal GW having the high gate voltage VGH may be generated based on the voltage of the inverted control node NQB.

In summary, a swing width of the gate signal GW between the high gate voltage VGH and the second low gate voltage VGL2 may be less than a swing width of the carry signal CR between the high gate voltage VGH and the first low gate VGL1. Accordingly, since the swing width of the gate signal GW is small, a power consumption of the gate driver 200 may be small.

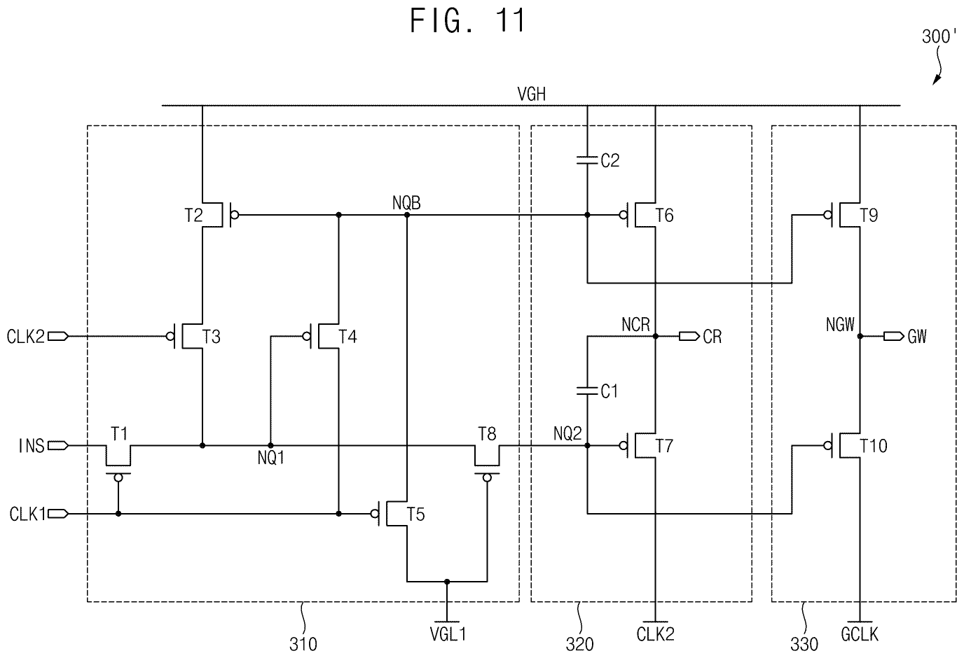

FIG. 11 is a circuit diagram showing an example of a stage 300′ included in the gate driver 200 of FIG. 3.

The stage 300′ of FIG. 11 is substantially to the same as the stage 300 of FIG. 5, except that the signal applied to the gate electrode of the third transistor T3 is a second clock signal CLK2 rather than a gate clock signal GCLK. Therefore, the same reference numbers are used for the same or similar components, and redundant descriptions are omitted.

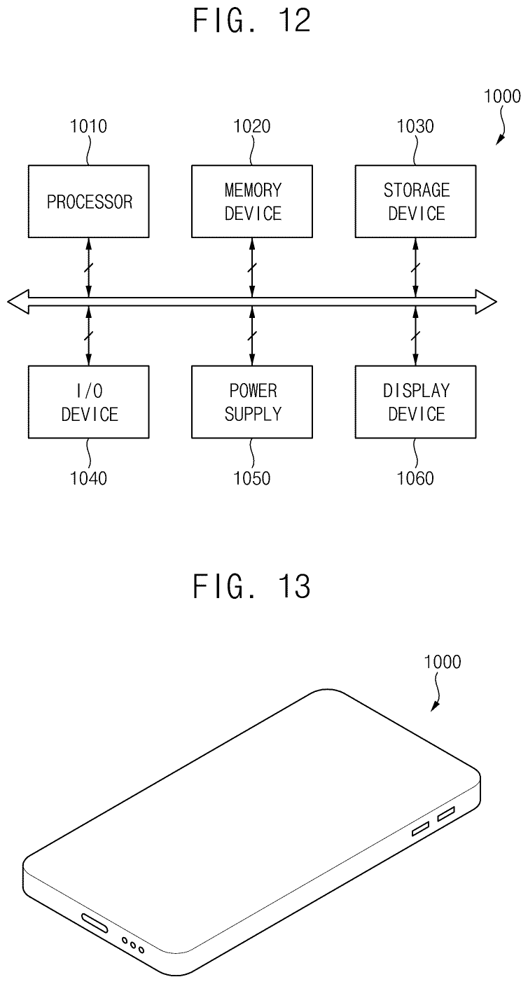

FIG. 12 is a block diagram showing an electronic device 1000. FIG. 13 is a diagram showing an embodiment in which an electronic device 1000 of FIG. 12 is implemented as a smart phone.

Referring to FIGS. 12 and 13, the electronic device 1000 may include a processor 1010, a memory device 1020, a storage device 1030, an input/output I/O device 1040, a power supply 1050, and a display device 1060. The display device 1060 may be the display device of FIG. 1. In addition, the electronic device 1000 may further include a plurality of ports for communicating with a video card, a sound card, a memory card, a universal serial bus USB device, other electronic device, and the like.

In an embodiment, as illustrated in FIG. 13, the electronic device 1000 may be implemented as the smart phone. However, the electronic device 1000 is not limited thereto. For example, the electronic device 1000 may be implemented as a cellular phone, a video phone, a smart pad, a smart watch, a tablet PC, a car navigation system, a computer monitor, a laptop, a head mounted display HMD device, and the like.

The processor 1010 may perform various computing functions. The processor 1010 may be a micro processor, a central processing unit CPU, an application processor AP, and the like. The processor 1010 may be coupled to other components via an address bus, a control bus, a data bus, and the like. Further, the processor 1010 may be coupled to an extended bus such as a peripheral component interconnection PCI bus.

The memory device 1020 may store data for operations of the electronic device 1000. For example, the memory device 1020 may include at least one nonvolatile memory device such as an erasable programmable read-only memory EPROM device, an electrically erasable programmable read-only memory EEPROM device, a flash memory device, a phase change random access memory PRAM device, a resistance random access memory RRAM device, a nano floating gate memory NFGM device, a polymer random access memory PoRAM device, a magnetic random access memory MRAM device, a ferroelectric random access memory FRAM device, and the like and/or at least one volatile memory device such as a dynamic random access memory DRAM device, a static random access memory SRAM device, a mobile DRAM device, and the like.

The storage device 1030 may include a solid state drive SSD device, a hard disk drive HDD device, a CD-ROM device, and the like.

The I/O device 1040 may include an input device such as a keyboard, a keypad, a mouse device, a touch-pad, a touch-screen, and the like, and an output device such as a printer, a speaker, and the like. In some embodiments, the I/O device 1040 may include the display device 1060.

The power supply 1050 may provide power for operations of the electronic device 1000.

The display device 1060 may be connected to other components through buses or other communication links.

The inventive concepts may be applied to any display device and any electronic device including the touch panel. For example, the inventive concepts may be applied to a mobile phone, a smart phone, a tablet computer, a digital television TV, a 3D TV, a personal computer PC, a home appliance, a laptop computer, a personal digital assistant PDA, a portable multimedia player PMP, a digital camera, a music player, a portable game console, a navigation device, etc.

The foregoing is illustrative of the inventive concept and is not to be construed as limiting thereof. Although a few embodiments of the inventive concept have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims. In the claims, means-plus-function clauses are intended to cover the structures described herein as performing the recited function and not only structural equivalents but also equivalent structures. Therefore, it is to be understood that the foregoing is illustrative of the inventive concept and is not to be construed as limited to the specific embodiments disclosed, and that modifications to the disclosed embodiments, as well as other embodiments, are intended to be included within the scope of the appended claims. The inventive concept is defined by the following claims, with equivalents of the claims to be included therein.

What is claimed is:

1. A gate driver including a plurality of stages, wherein each of the stages comprises:
a control circuit configured to receive an input signal in response to a first clock signal and control a voltage of a control node and a voltage of an inverted control node based on the input signal;
a carry output circuit configured to output a high gate voltage or a second clock signal as a carry signal in response to the voltage of the control node and the voltage of the inverted control node; and
a gate output circuit configured to output the high gate voltage or a gate clock signal as a gate signal in response to the voltage of the control node and the voltage of the inverted control node.

2. The gate driver of claim 1, wherein the second clock signal has a swing width between the high gate voltage and a first low gate voltage, and the gate signal has a swing width between the high gate voltage and a second low gate voltage different from the first low gate voltage.

3. The gate driver of claim 2, wherein the first low gate voltage is lower than the second low gate voltage.

4. The gate driver of claim 1, wherein the carry output circuit includes:
a sixth transistor including a gate electrode connected to the inverted control node, a first electrode receiving the high gate voltage, and a second electrode connected to a carry output node from which the carry signal is output; and
a seventh transistor including a gate electrode connected to the control node, a first electrode receiving the second clock signal, and a second electrode connected to the carry output node.

5. The gate driver of claim 4, wherein that the carry output circuit further includes a first capacitor including a first electrode connected to the control node and a second electrode connected to the carry output node.

6. The gate driver of claim 5, wherein the carry output circuit further includes a second capacitor including a first electrode receiving the high gate voltage and a second electrode connected to the inverted control node.

7. The gate driver of claim 1, wherein the gate output circuit includes:
a first gate output transistor including a gate electrode connected to the inverted control node, a first electrode receiving the high gate voltage, and a second electrode connected to a gate output node; and
a second gate output transistor including a gate electrode connected to the control node, a first electrode receiving the gate clock signal, and a second electrode connected to the gate output node.

8. The gate driver of claim 1, wherein the control circuit includes:
a first transistor including a gate electrode receiving the first clock signal, a first electrode receiving the input signal, and a second electrode connected to the control node;
a second transistor including a gate electrode connected to the inverted control node, a first electrode receiving the high gate voltage, and a second electrode;
a fourth transistor including a gate electrode connected to the control node, a first electrode receiving the first clock signal, and a second electrode connected to the inverted control node; and
a fifth transistor including a gate electrode receiving the first clock signal, a first electrode receiving a first low gate voltage, and a second electrode connected to the inverted control node.

9. The gate driver of claim 8, wherein the control circuit further includes a third transistor including a gate electrode receiving the gate clock signal, a first electrode connected to the control node, and a second electrode connected to the second electrode of the second transistor.

10. The gate driver of claim 8, wherein the control circuit further includes a third transistor including a gate electrode receiving the second clock signal, a first electrode connected to the control node, and a second electrode connected to the second electrode of the second transistor.

11. The gate driver of claim 8, wherein the control node includes a first control node and a second control node, and the control circuit further includes an eighth transistor including a gate electrode receiving a first low gate voltage, a first electrode connected to the first control node, and a second electrode connected to the second control node.

12. A display device, comprising:
a display panel including a plurality of pixels; and
a gate driver configured to apply a gate signal to the pixels,
wherein the gate driver includes a plurality of stages, and
each of the stages includes:
a control circuit configured to receive an input signal in response to a first clock signal and control a voltage of a control node and a voltage of an inverted control node based on the input signal;
a carry output circuit configured to output a high gate voltage or a second clock signal as a carry signal in response to the voltage of the control node and the voltage of the inverted control node; and
a gate output circuit configured to output the high gate voltage or a gate clock signal as the gate signal in response to the voltage of the control node and the voltage of the inverted control node.

13. The display device of claim 12, wherein the second clock signal has a swing width between the high gate voltage and a first low gate voltage, and the gate signal has a swing width between the high gate voltage and a second low gate voltage different from the first low gate voltage.

14. The display device of claim 13, wherein the first low gate voltage is lower than the second low gate voltage.

15. The display device of claim 12, wherein the carry output circuit includes:
a sixth transistor including a gate electrode connected to the inverted control node, a first electrode receiving the high gate voltage, and a second electrode connected to a carry output node from which the carry signal is output; and
a seventh transistor including a gate electrode connected to the control node, a first electrode receiving the second clock signal, and a second electrode connected to the carry output node.

16. The display device of claim 15, wherein that the carry output circuit further includes a first capacitor including a first electrode connected to the control node and a second electrode connected to the carry output node.

17. The display device of claim 16, wherein the carry output circuit further includes a second capacitor including a first electrode receiving the high gate voltage and a second electrode connected to the inverted control node.

18. The display device of claim 12, wherein the gate output circuit includes:
a first gate output transistor including a gate electrode connected to the inverted control node, a first electrode receiving the high gate voltage, and a second electrode connected to a gate output node; and
a second gate output transistor including a gate electrode connected to the control node, a first electrode receiving the gate clock signal, and a second electrode connected to the gate output node.

19. The display device of claim 12, wherein the control circuit includes:
a first transistor including a gate electrode receiving the first clock signal, a first electrode receiving the input signal, and a second electrode connected to the control node;
a second transistor including a gate electrode connected to the inverted control node, a first electrode receiving the high gate voltage, and a second electrode;
a fourth transistor including a gate electrode connected to the control node, a first electrode receiving the first clock signal, and a second electrode connected to the inverted control node; and
a fifth transistor including a gate electrode receiving the first clock signal, a first electrode receiving a first low gate voltage, and a second electrode connected to the inverted control node.

20. The display device of claim 19, wherein the control circuit further includes a third transistor including a gate electrode receiving the gate clock signal, a first electrode connected to the control node, and a second electrode connected to the second electrode of the second transistor.

21. An electronic device, comprising:
a display panel including a plurality of pixels;
a gate driver configured to apply a gate signal to the pixels; and
a power supply configured to apply a power to the display panel and the gate driver,
wherein the gate driver includes a plurality of stages, and
each of the stages includes:
a control circuit configured to receive an input signal in response to a first clock signal and control a voltage of a control node and a voltage of an inverted control node based on the input signal;
a carry output circuit configured to output a high gate voltage or a second clock signal as a carry signal in response to the voltage of the control node and the voltage of the inverted control node; and
a gate output circuit configured to output the high gate voltage or a gate clock signal as the gate signal in response to the voltage of the control node and the voltage of the inverted control node.
